(19) United States
(12) Patent Application Publication
(10) Pub. No.: US 2005/0072315 A1
(43) Pub. Date: Apr. 7, 2005

(54) Cooking assembly

(76) Inventor: Emmanuel Romero, Saint-Marcel Les Annonay (FR)

Correspondence Address: YOUNG & THOMPSON, 745 SOUTH 23RD STREET, 2ND FLOOR, ARLINGTON, VA, 22202, US

(21) Appl. No.: 10/695,387

(22) Filed: Oct. 29, 2003

(30) Foreign Application Priority Data
Oct. 30, 2002 (FR) 02 13613

(51) Int. Cl. A47J 37/12

(52) U.S. Cl. 99/403

(57) ABSTRACT

A cooking assembly comprises a bath 2 forming a cavity open at the top designed to be able to take liquid and equipped with heating elements 24 situated outside the cavity, and a peripheral trough 5 surrounding the upper edge 4 of the bath 2 to collect condensate.

The present invention relates to a cooking assembly, particularly to a cooking assembly allowing the cooking of varying products, using different cooking methods, in small or large quantities.

Cooking devices used in particular in commercial catering generally comprises special-purpose cooking modules such as pans, for boiling vegetables, pasta or rice, pasta cookers or steamers which are designed for preparing significant amounts of products. Such cooking modules are not well suited to the preparation of small quantities of products or “portions”.

The cooking of portions of vegetables, pasta, rice or fish is generally performed using vessels placed on heat sources such as hotplates or gas burners. The use of the hotplates for preparing portions, particularly portions of vegetables or of fish, monopolizes these hotplates and prevents them from being used to prepare products for which they are indispensable. Furthermore, the preparation of portions of vegetables, pasta, rice or fish using such vessels employed with hotplates requires numerous handling operations to fill and empty these vessels. In addition, when boiling or steaming, there are risks that products will spill over onto the hob, possibly requiring subsequent cleaning. What is more, in order to maintain the accessibility to other hotplates which are used to prepare products that require attention and the presence of the person preparing them, the vessels used for cooking portions are generally arranged on the back burners of hob modules. This results in poor ergonomics because the vessels are distant from the edge of a cooking module. Furthermore, the performance obtained when cooking portions using such utensils varies according to the type and quality of vessel used, as the vessel may be too large, or not large enough with respect to the size of the hotplate, or may have a dented bottom.

The subject of the present invention is a cooking assembly allowing the preparation of significant quantities or of portions, and particularly of several portions at the same time.

Another subject of the invention is a cooking assembly allowing the preparation of products using various cooking modes, particularly by immersing in water, steaming or by contact with a hot element.

The invention also relates to a cooking assembly having satisfactory ergonomics and improved hygiene, designed to avoid the overspilling of liquid and allowing condensate or liquid to be collected while at the same time preventing any liquid accidentally spilt on a work surface from contaminating the bath.

Such a cooking assembly comprises a bath forming a cavity open at the top designed to be able to take liquid and equipped with heating means, a peripheral trough surrounding the upper edge of the bath and heating elements situated outside the cavity.

The bath forming a cavity open at the top, that can be filled with liquid and equipped with means for heating the liquid, allows products such as vegetables, pasta or rice to be boiled in the water, and in large quantities. The heating elements situated on the outside allow products tipped directly into the bath to be heated. The products will not be in contact with the heating elements which will therefore not become soiled. Furthermore, the heating elements situated outside make the bath easier to clean after use for bulk cooking, directly in the bath. When cooking using a liquid placed in the bottom of the bath, there is no need to provide a minimum depth of liquid in the bottom of the bath.

The products can be cooked using heated water or may be placed directly on the heated bottom of the cooking bath, for example to seal meat or fish. Advantageously, the bottom may be thick enough to have mechanical integrity when heated to high temperatures, of the order of 400° C., allowing cooking by contact, and to offer enough heating inertia to such cooking. The bottom may be thicker than the side walls of the bath.

The peripheral trough surrounding the upper edge of the bath makes it possible, for example when cooking in saturated steam, which is made possible by placing a lid over the cooking assembly, to collect the condensate formed on the lid or on the support frame. Furthermore, the peripheral trough surrounding the cooking bath makes it possible to prevent products, particularly liquids which have fallen onto a work surface surrounding the cooking bath, from dropping into the bath and contaminating the liquid or products while they are cooking. Advantageously, the trough forms, with the cooking bath, a profile that allows cooking accessories to be hooked over the upper edge of the bath.

Advantageously, the cooking assembly comprises a removable support frame designed to be placed removably against the upper edge of the bath and equipped with hooking means for suspending at least one cooking basket. The removable support frame designed to be placed on the upper edge of the bath allows cooking baskets to be suspended. The support frame may allow several small-sized baskets to be suspended at the same time for cooking different portions, whether that be by dipping them into the water or by saturating them in steam, using perforated baskets, or by heating a basket in the manner of a bain-Marie, using solid-walled baskets. The frame defines a support of dimensions suited to those generally encountered in cooking baskets.

In one embodiment, the support frame comprises a peripheral skirt designed to surround an internal peripheral wall of the peripheral trough when the support frame is placed on the upper edge of the bath. The peripheral skirt allows the support frame to be centred on the bath and can be produced in a simple way. The removable support frame is positioned on the cooking bath in a simple and reliable way without the risk of the support frame falling over. Furthermore, the support frame, when placed on the bath, forms a peripheral passage for condensation opening into the peripheral trough.

In one embodiment, the hooking means comprise strips arranged on an interior periphery of the support frame. The strips projecting towards the inside of the support frame form surfaces on which the edges of baskets can rest so that the baskets can be suspended over the cooking bath. The hooking strips may be arranged continuously around the interior periphery of the support frame or be split into sectors, designed for suspending baskets of different sizes.

Advantageously, the hooking means comprise at least one transverse strip to divide the support frame. One transverse strip is able to provide a bearing surface, particularly for a cooking basket which is smaller than the size defined by the hooking strips arranged around an interior periphery of the support frame.

As a preference, one transverse strip is removable and designed to rest on periphery strips. The position of the transverse strip can easily be altered to suit the size of the cooking baskets envisaged. The removable transverse strip can be removed, for example so as to suspend a large-sized basket which can be suspended directly from the interior periphery strips of the support frame.

In one embodiment, the cooking assembly comprises a lid designed to rest on the support frame, closing an upper opening of the cavity. The lid allows saturation steam cooking directly in the bath, in a large-sized bath suspended from the support frame, or alternatively in a number of portion-cooking baskets suspended from the support frame. When cooking in saturated steam, condensate forms on the underside of the lid and can run down to a periphery of the lid where it will be collected in the peripheral trough.

In one embodiment, the cooking assembly comprises filtering means, such as a strainer, obstructing a drain for removing liquid contained in the cavity of the bath. As a preference, the drain for removing the liquid opens into the bottom of the bath. The filtering means allow the bath to be used for cooking products directly by immersing them in water.

In one embodiment, the cooking assembly comprises a drain for the trough for removing a liquid present in the trough. Such a drain may be permanent, that is to say it remains open for continuous removal of liquid present in the trough.

The present invention and its advantages will be better understood from studying the detailed description of one embodiment taken by way of entirely non-limiting example and illustrated by the attached drawings, in which:

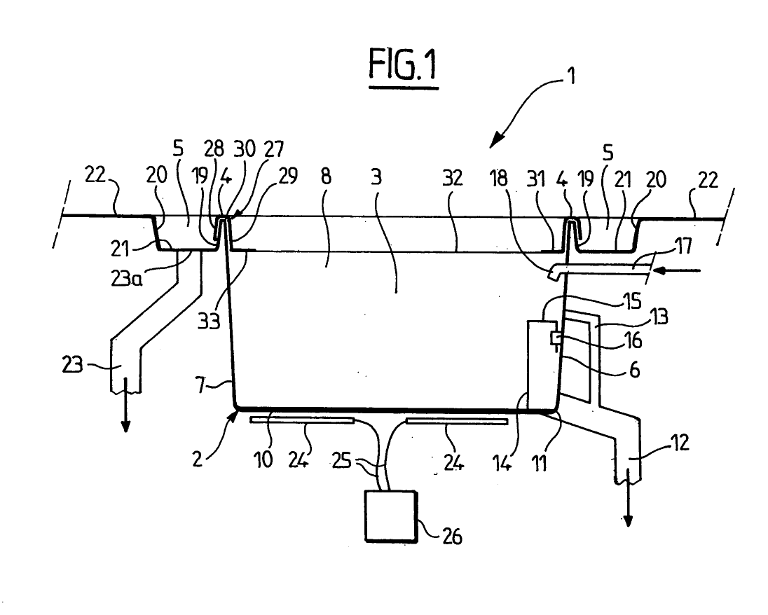

FIG. 1 is a view in section on I/I of a cooking assembly according to one aspect of the invention;

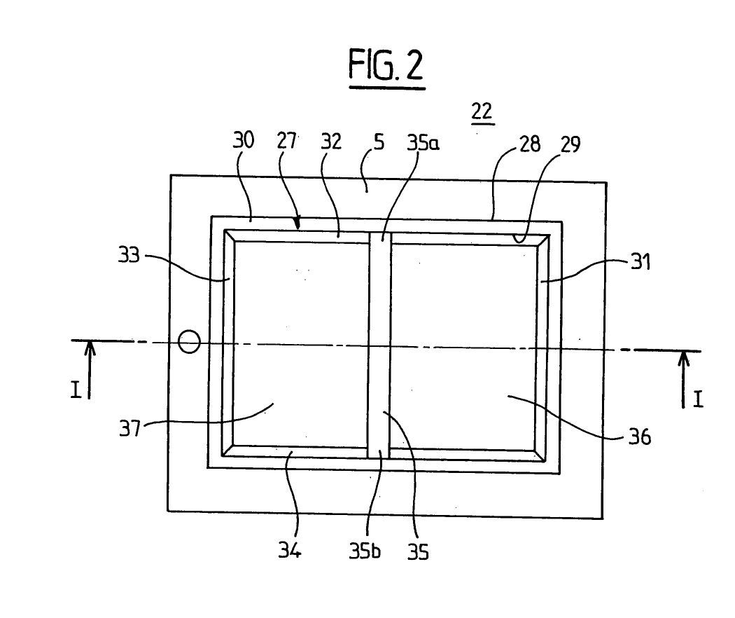

FIG. 2 is a view from above of the cooking assembly of FIG. 1, equipped with an element for dividing a support frame;

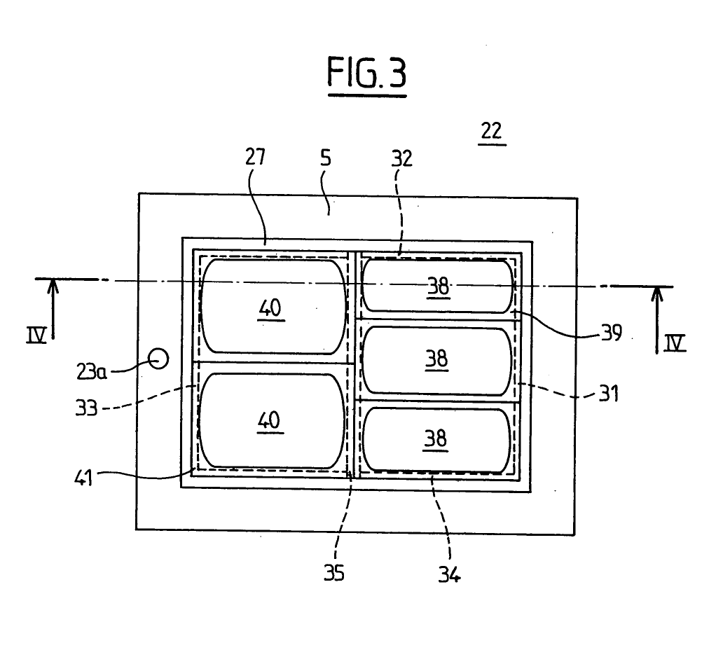

FIG. 3 is a view from above of the cooking assembly of FIG. 2 equipped with cooking baskets; and

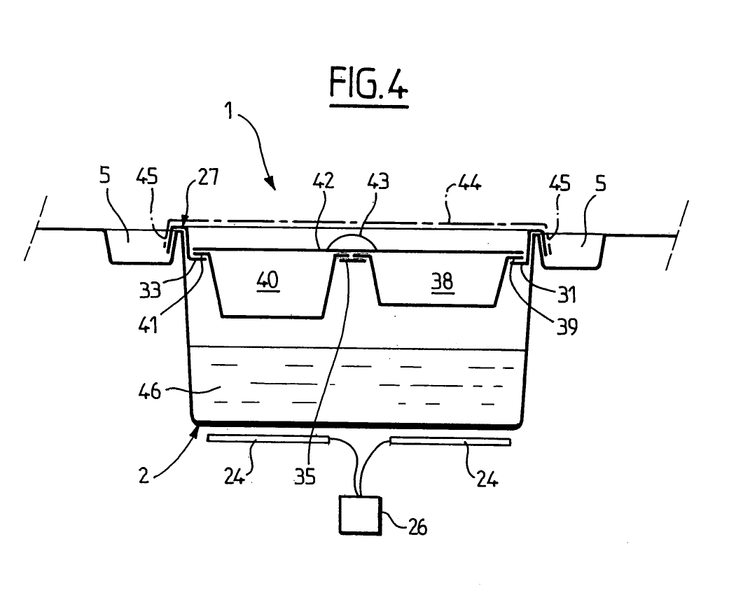

FIG. 4 is a view in section on IV/IV of the cooking assembly according to FIG. 3.

In FIG. 1, a cooking assembly referenced 1 in its entirety comprises a cooking bath 2 forming a cavity 3 open at the top and having an upper edge 4 and a peripheral trough 5 surrounding the upper edge 4 of the cooking bath 2.

The cooking bath 2 which, when viewed from above, has a rectangular overall shape, comprises two short side walls 6, 7 and long side walls 8, 9 only one of which is visible in FIG. 1, and a bottom wall 10. The cooking bath 2 comprises a drain in the form of an orifice 11 formed where the first short side wall 6 meets the bottom 10, extended by a discharge pipe 12. An overflow device comprises a tube 13 opening, at one end, onto the first short side wall 6, approximately mid-way up its height, and at the opposite end, into the discharge duct 12. The bottom wall 10 may be inclined slightly towards the first short side wall 6 to encourage liquid to be removed towards the orifice 11 of the discharge pipe 12. Furthermore, the bottom wall 10 is thicker than the side walls 6 to 9.

Filtering means in the form of a perforated strainer 14 are provided to prevent product from passing through the discharge pipe 12. The grating 14 is in the form of a perforated plate 14 comprising a fixing arm 5 designed to collaborate with the blocks 16 fixed to the short side wall 6, coming into contact with the bottom wall 10, and comprising turned-down edges not visible in FIG. 1, and coming into contact with the short side wall 6.

The cooking bath 2 also comprises a feed duct 14 for supplying liquid to a feed nozzle 18 arranged on the first short side wall 6, above the height of the orifice of the overflow tube 13 situated on the first short side wall 6.

The peripheral trough 5 has, in cross section, a more or less rectangular profile open at the top and comprises an inner wall 19, an outer wall 20 and a bottom wall 21. The upper edge of the outer wall 20 lies in a horizontal plane defined by a work surface 22. It will be noted that the upper edge of the inner wall 19, and the upper edge 4 of the cooking bath 2 also lie in the plane of the work surface 22.

It will also be noted that the work surface 22, the peripheral trough 5 and the walls of the cooking bath 2 may be formed of one and the same sheet of material or of sheets of material that are assembled, for example by welding, so that the peripheral trough 5 and the cooking bath 2 have an upwardly facing surface with no discontinuities when travelling from the outside of the trough 5 towards the inside of the cooking bath 2.

On the same side as the second short side wall 7 of the support bath 2, the peripheral trough 5 has a drain in the form of a discharge pipe 23 opening at one end 23a into the peripheral trough 5, flush with the bottom wall 21.

The cooking assembly 1 also comprises heating elements 24, in this instance two of these, powered by connection 25 by a power supply unit 26 connected in a way not depicted to a power source. The heating elements 24 are situated outside the cavity of the bath 2 under the bottom wall 10. As the heating elements 24 are situated outside the bath 2, it is possible to provide heating elements 24 of the electrical type for irradiative heating of the bottom wall 10, or gas-powered elements, of the burner type, provided with ducts for removing the products of combustion.

The cooking assembly 1 comprises a support frame 27 having, in cross section, a roughly U-shaped profile with the opening directed downwards with one arm situated inside the support frame that is longer than arm that is situated outside the support frame 27.

The support frame 27 comprises an outer portion 28 designed to surround the interior wall 19 of the peripheral trough 5, an inner portion 29 designed to be surrounded by the upper portion of the side walls 6 to 9 of the cooking bath 2, and an intermediate portion 30 connecting the upper edges of the outer 28 and inner 29 portions. The support frame 27 comprises suspension strips 31 to 34, one strip 34 not being visible in FIG. 1, fixed to the lower edge of the inner portion 29 and projecting towards the inside of the support frame 27, more or less horizontally. There are four suspension strips 31 to 34 arranged on the interior periphery of the support frame 27, along the four sides.

In FIG. 2, the support frame 27 is equipped with a removable strip 35, of a length roughly equal to the length of a short side of the support frame 27, and resting via its ends 35a, 35b on the long-side support strips 32, 34 of the support frame 27. The removable strip 35 runs parallel to the short-side support strips 31, 33 of the support frame 27. The position of the strip 35 on the support strips 32, 34 can be chosen, that is to say that it is possible to choose the distance separating the removable strip 35 from, on the one hand, the first short-side strip 31 and from the second short-side strip 33. The removable strip 35 allows the support frame 27 to be split into two frames 36, 37 of smaller size. The first frame 36 is defined by the removable strip 35, by a portion of the first long-side strip 32, the short-side strip 31 and a portion of the second long-side strip 34. The second small frame 37 is defined by the removable strip 35, a portion of the first long-side strip 32, the second short-side strip 33 and a portion of the second long-side strip 34.

In FIG. 3, cooking baskets are suspended from the support frame 27 equipped with the removable dividing strip 35 depicted in dotted line. Three similar small-portion baskets 38 are suspended in the small support frame 36. A basket is in the form of a vessel the upper edge of which is extended by a flange 39 allowing the basket 38 to be suspended. The baskets 38 are arranged with their adjacent edges in contact, that is to say that a basket has a length roughly equal to the width of the support frame 36, and a width roughly equal to one third of the length of the small support frame 36. Two lateral baskets 38 are in contact via their flange 39 with a portion of the removable dividing strip 35, on the opposite side with a portion of the short-side strip 31, and on a lengthwise side with a portion of a long-side strip 32, 34 of the support frame 27. The basket 38 in the middle bears, on one side, against a central portion of the removable strip and, on the opposite side, on a central portion of the first short-side strip 31 of the support frame 27.

Two large-portion baskets 40 are arranged suspended using the second small support frame 37. A basket 40 comprises a flange 41 resting, on one side, against the removable dividing strip 35 and, on the opposite side, against the second short-side strip 33 of the support frame, and on one side, against a portion of the first long-side strip 32 of the support frame 27. The baskets 40 are in contact with one another along the free edges of their flange 41.

The removable dividing strip 35 therefore, by forming smaller-sized support frames 36, 37, allows portion baskets of sizes smaller than those of the support frame 27 to be suspended. Furthermore, the use of a plurality of cooking baskets suspended simultaneously using the support frame 27 allows the simultaneous preparation of a plurality of portions made up of different products and cooked using the same cooking method.

Of course, a large-sized basket suspended directly from the four strips 31 to 34 of the support frame 27 could be envisaged.

In FIG. 4, the support baskets 38 and 40 are covered with a lid 42 equipped with a handle 43 and resting directly on the upper edges of the cooking baskets 38, 40. It is also possible to provide a lid 44 in the form of a rectangular plate of dimensions appreciably greater than those of an external periphery of the support frame 27 and equipped on its periphery with a skirt 45 extending downwards from the edge of the plate 44 to surround the support frame 27.

As depicted in FIG. 4, the bath 2 is filled with a liquid 46, to more or less one third of its depth.

The way in which the cooking assembly works is described hereinafter, keeping the references used for FIGS. 1 to 4 described hereinabove.

In a first mode of operation, the cooking bath can be used to cook products by immersing them in heated water. To do this, the bath 2 is filled using the water feed nozzle 18, taking care beforehand to prevent water from leaving via the discharge duct 12, for example by plugging the orifice 11 of the discharge duct 12. Next, the product can be immersed directly in the water. When the products are cooked, the products can be retrieved then the water can be emptied out or the water can be emptied out and the products, which are prevented from leaving via the discharge duct 12 by the filtration grating 14, can be retrieved.

In a second mode of operation, provision may be made for the support frame 27 to be arranged on the upper edge 4 of the cooking bath 2, and for just one large-sized cooking basket to be suspended therefrom.

It is possible to provide a solid-walled cooking basket. In this case, the cooking bath 2 may be filled with water to a level below a lower end of the cooking bath. The heat is applied to the cooking basket via steam formed between the upper surface of the liquid and the cooking baskets, in the fashion of a bain-Marie.

A perforated cooking basket may also be provided, with the cooking bath 2 filled to a level above the level of a bottom wall of the cooking basket, so that the products are cooked directly in the water. In this case, the products cooked by immersing them in the water are retrieved simply by retrieving the cooking basket, which then also acts as a colander.

Provision may also be made to use baskets designed to take bags of vacuum-packed precooked food designed to be brought up to temperature by immersing the vacuum-packed bag in water. Given the dimensions generally used for such vacuum-packed bags, it is often necessary to provide baskets larger than portion-sized cooking baskets, which means that a support frame designed for cooking baskets is not suitable for supporting baskets for immersing vacuum-packed bags. In this case, provision may advantageously be made for there to be baskets for the immersion of vacuum-packed bags, equipped with means for hooking them directly over the edge of the bath, hooking onto the rim formed at the periphery of the upper edge of the bath 2. In this case, it will be possible to remove the support frame for hooking on one or more baskets for the immersion of vacuum-packed bags.

Provision may also be made for the cooking bath 2 to be filled with water to a level below that of the bottom of the perforated cooking basket and for the cooking bath 2 to be closed using a lid 42 closing the cooking bath or a lid 44 covering the support frame 27. In this case, the products are cooked in a saturated steam atmosphere.

The various cooking modes mentioned before may be implemented for small quantities of products or portions, using compartmentalization of the support frame 27, for example using a dividing strip, and a number of cooking baskets containing various products.

To cook various portions simultaneously using the same cooking bath, it is possible to provide a cooking basket suspended on strips at the periphery of the support frame and comprising a plurality of receptacles separated by walls so that each can contain a different product. However, such an embodiment does not allow the withdrawal of a basket containing a particular product which has finished cooking.

As the heating elements are situated outside the cavity defined by the cooking bath 2, under the bottom wall 10, they are not in contact with the products cooked loose and in bulk in the cooking bath. As a consequence, there is no risk that the heating elements 24 will become soiled and require cleaning that may prove tiresome, or of them impeding the cleaning of the bottom of the tank. Furthermore, in the case where cooking is being done with a low fill level of the cooking bath 2, there is no need to provide a minimum height of water to cover the heating elements. The heating elements heat the bottom wall 10 of the cooking bath 2 directly and this transmits heat by conduction to the water situated in the bottom of the cooking bath 2.

Furthermore, the heating elements situated outside the tank allow the tank bottom, which is preferably thick, to be used for contact cooking, for example for frying onions or a piece of meat.

When cooking with the baskets covered over or in saturated steam, with the top opening of the cooking bath closed using a lid, steam may be deposited in the form of condensate on an underside of the support frame 27 or of the lid 44. The walls of these lids droping down and defining skirts surrounding an interior wall 19 of a peripheral trough 9 define a forced path for the condensate and, because of their contact with ambient air and their remoteness from the heating sources, have a lower temperature encouraging condensation, so that the steam that would have a tendency to escape condenses on the interior surfaces of these walls and flows in liquid form to be collected in the peripheral trough 5. These skirts form a condensation path and path for the peripheral passage of the condensate.

Furthermore, it will be noted that the upper edge of the cooking bath lies more or less in the work surface 22 which means that there is nothing projecting from the work surface that might obstruct someone handling cooling utensils. If product or liquid drops onto the work surface 22, the peripheral trough 5 prevents it from running into the cooking bath 2 and contaminating its contents. The peripheral trough 5 acts as a barrier against contaminants.

By virtue of the invention, there is obtained a cooking assembly that makes it possible to cook large quantities of products or to cook portions of products for preparation of smaller and more varied quantities, using different modes of cooking depending on the products that are to be prepared. The switch from one cooking mode to another can be done quickly. The cooking assembly is easy to maintain. The switch from a mode of cooking large quantities to a mode of cooking portions is done simply by placing a support frame or, when the support frame has already been placed, simply by using different cooking baskets, particularly by splitting up the support frame into smaller sized adjacent frames. The peripheral trough allows any condensate that might form in saturated steam cooking mode to be removed or allows any liquids running along the work surface to be collected.

The cooking assembly, according to an aspect of the invention, comprises a bath forming a cavity open at the top and equipped with heating means designed to allow both contact cooking, to seal or fry, and cooking by immersion in a liquid directly in the bath, without the use of a basket. The cooking assembly also allows cooking in an atmosphere containing steam, or by heating a basket using heated water, that is to say in the fashion of a bain-Marie, this being without the need to provide a significant amount of water in the bath.

1-13. (cancelled)

14. Cooking assembly comprising:
a bath forming a cavity having an open top and able to take liquid, a bottom wall and a peripheral trough surrounding an upper edge of the bath; and
a heating means with heating elements situated outside the cavity, under the bottom wall for directly heating the bottom wall.

15. Assembly according to claim 14, further comprising accessories designed to be hooked over the upper edge of the bath.

16. Assembly according to claim 14, further comprising a removable support frame designed to be placed removably against the upper edge of the bath and equipped with hooking means for suspending at least one cooking basket.

17. Assembly according to claim 16, wherein the support frame comprises a peripheral skirt surrounding an internal peripheral wall of the peripheral trough when the support frame is placed on the upper edge of the bath.

18. Assembly according to claim 16, wherein the hooking means comprise strips arranged on an interior periphery of the support frame.

19. Assembly according to claim 14, wherein the hooking means comprise at least one transverse strip dividing the support frame.

20. Assembly according to claim 19, wherein the one transverse strip is removable and rests on periphery strips.

21. Assembly according to claim 14, further comprising a lid resting on the support frame, closing an upper opening of the cavity.

22. Assembly according to claim 14, further comprising filtering means obstructing a drain for removing liquid contained in the cavity of the bath.

23. Assembly according to claim 14, further comprising a drain for the peripheral trough for removing a liquid present in the peripheral trough.

24. Assembly according to claim 14, wherein the bottom wall of the bath is thicker than the side walls of the bath.

25. Assembly according to claim 15, further comprising a removable support frame designed to be placed removably against the upper edge of the bath and equipped with hooking means for suspending at least one cooking basket.

26. Assembly according to claim 17, wherein the hooking means comprise strips arranged on an interior periphery of the support frame.

27. Cooking assembly comprising:
a bath forming a cavity having an open top and able to take liquid, a bottom wall and a peripheral trough surrounding an upper edge of the bath;
a heating means situated outside the cavity; and
a removable support frame designed to be placed removably against the upper edge of the bath and hooking means for suspending at least one cooking basket.

28. Cooking assembly comprising:
a bath forming a cavity open at the top to take liquid and equipped with heating means;
a peripheral trough surrounding the upper edge of the bath;
heating elements situated outside the cavity; and
a removable support frame removably placeable against the upper edge of the bath and equipped with hooking means for suspending at least one cooking basket.

29. Assembly according to claim 28, wherein the support frame comprises a peripheral skirt surrounding an internal peripheral wall of the peripheral trough.

30. Assembly according to claim 28, wherein the hooking means comprise strips arranged on an interior periphery of the support frame.
